(19) United States
(12) Patent Application Publication
(10) Pub. No.: US 2018/0047464 A1
(43) Pub. Date: Feb. 15, 2018

(54) MUON-CATALYZED FUSION ON THIN-ATMOSPHERE PLANETS OR MOONS USING COSMIC RAYS FOR MUON GENERATION

(71) Applicant: Jerome Drexler, Los Altos Hills, CA (US)

(72) Inventor: Jerome Drexler, Los Altos Hills, CA (US)

(21) Appl. No.: 15/673,088

(22) Filed: Aug. 9, 2017

Related U.S. Application Data
(60) Provisional application No. 62/372,618, filed on Aug. 9, 2016.

(51) Int. Cl. G21B 3/00; G21B 1/19; G21B 1/21

(52) U.S. Cl. CPC G21B 3/004; G21B 1/21; G21B 1/19; G21C 1/00

(57) ABSTRACT

In various units, a coating of chips or pellets comprising a deuterium-containing micro-fusion fuel material produce energetic reaction products and/or EM radiation in the presence of an ambient flux of cosmic rays and muons generated from the cosmic rays. The chips may contain solid Li⁶D or encapsulate liquid or frozen D₂O. Micro-fusion reactions proceed via muon-catalyzed fusion, particle-target fusion, or both. These may produce usable heat for a space heater to heat surrounding spaces directly or communicate via circulating fluid with a heat exchanger located for more remote heating of spaces away from the generator. EM radiation can be converted to electricity, either directly or via heating of a circulating liquid and thermoelectric conversion. Mechanical work may also be performed by the energetic reaction products, wherein a coated panel mounted on a transport vehicle may serve as a propulsion unit, the energetic reaction products directly providing horizontal thrust or providing electricity via heating (as before) to drive the vehicle. Other mechanical devices include paddle wheels coated with the chips to generate rotary motion, and levers coated on one lever arm to produce a beneficial force at the other lever arm.

### CROSS-REFERENCE TO RELATED APPLICATION

This application claims priority under 35 U.S.C. 119(e) from prior U.S. provisional application 62/372,618, filed Aug. 9, 2016.

### TECHNICAL FIELD

The present invention relates to inducement or production of controlled nuclear micro-fusion using fuels in solid pellet, chip, capsule or other condensed-matter forms, for use on surfaces of the Moon, Mars, on other planets or moons having little or no magnetic field and/or atmosphere, and at very-high Earth altitudes, and relates in particular to muon-catalyzed micro-fusion as well as particle-target micro-fusion from ambient irradiation and bombardment with high-energy cosmic rays and their muon decay products.

### BACKGROUND ART

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an earth-based fusion source, since it falls short of breakeven potential.

Another controlled fusion technique is particle-target fusion which comes from accelerating a particle to sufficient energy so as to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that abundant muons can be derived from the decay of cosmic rays passing through a planet's atmosphere. Cosmic rays are mainly high-energy protons (with some high-energy helium nuclei as well) having kinetic energies in excess of 300 MeV. Most cosmic rays have GeV energy levels, although some extremely energetic ones can exceed 10¹⁸ eV. FIG. 7 shows cosmic ray flux distribution at the Earth's surface after significant absorption by Earth' atmosphere has occurred. In near-Earth space, the alpha magnetic spectrometer (AMS-02) instrument aboard the International Space Station since 2011 has recorded an average of 45 million fast cosmic ray particles daily (approx. 500 per second). The overall flux of galactic cosmic ray protons (above earth's atmosphere) can range from a minimum of 1200 m⁻² s⁻¹ sr⁻¹ to as much as twice that amount. (The flux of galactic cosmic rays entering our solar system, while generally steady, has been observed to vary by a factor of about 2 over an 11-year cycle according to the magnetic strength of the heliosphere.)

In regions that are outside of Earth's protective magnetic field (e.g. in interplanetary space, or on planets or moons lacking a strong magnetic field), the cosmic ray flux is expected to be several orders of magnitude greater. As measured by the Martian Radiation Experiment (MARIE) aboard the Mars Odyssey spacecraft, average in-orbit cosmic ray doses were about 400-500 mSv per year, which is at least an order of magnitude higher than on Earth.

It is known that as cosmic rays lose energy upon collisions with atmospheric dust, and to a lesser extent atoms or molecules, they generate elementary particles, including pions and then muons, usually within a penetration distance of a few cm. Typically, hundreds of muons are generated per cosmic ray particle from successive collisions. For example, near sea level on Earth, the flux of muons generated by the cosmic rays' interaction by the atmosphere averages about 70 m⁻² s⁻¹ sr⁻¹. The muon flux is even higher in the upper atmosphere. These relatively low flux levels on Earth reflect the fact that both Earth's atmosphere and geomagnetic field substantially shields our planet from cosmic ray radiation. Mars is a different story, having very little atmosphere (only 0.6% of Earth's pressure) and no magnetic field, so that cosmic ray flux and consequent muon generation at Mars' surface is expected to be very much higher than on Earth's surface.

In recent years, there have been proposals to send further spacecraft to Mars in 2018 and then manned space vehicles to Mars by 2025. One such development project is the Mars Colonial Transporter by the private U.S. company SpaceX with plans for a first launch in 2022 followed by flights with passengers in 2024. The United States has committed NASA to a long-term goal of human spaceflight and exploration beyond low-earth orbit, including crewed missions toward eventually achieving the extension of human presence throughout the solar system and potential human habitation on another celestial body (e.g., the Moon, Mars). As part of any manned exploration and human habitation of Mars, one or more forms of heating and lighting, and liquid water, will be needed for the habitats and life support.

### SUMMARY DISCLOSURE

Various units are described that use a coating of chips or pellets comprising a deuterium-containing micro-fusion fuel material to produce energetic reaction products and/or EM radiation in the presence of an ambient flux of cosmic rays and muons generated from the cosmic rays. The chips may contain solid Li⁶D or encapsulate liquid or frozen D₂O. Micro-fusion reactions proceed via muon-catalyzed fusion, particle-target fusion, or both. These may produce usable heat for a space heater to heat surrounding spaces directly or communicate via circulating fluid with a heat exchanger located for more remote heating of spaces away from the generator. EM radiation (usually, but necessarily exclusively, in the form of x-rays or gamma-rays) can be converted to electricity, either directly or via heating of a circulating liquid and thermoelectric conversion. Mechanical work may also be performed by the energetic reaction products, wherein a coated panel mounted on a transport vehicle may serve as a propulsion unit, the energetic reaction products directly providing horizontal thrust or providing electricity via heating (as before) to drive the vehicle. Other mechanical devices include paddle wheels coated with the chips to generate rotary motion, and levers coated on one lever arm to produce at the other lever arm.

Mars, with an atmospheric pressure that is only 0.6% of Earth's pressure, allows a substantial flux of cosmic rays to reach the planetary or lunar surface and its high mountains. Therefore, locating a solid fusion pellet or chip target on the surface of Mars (or any other planet or moon with a thin atmosphere) can make use of the muon generation from such cosmic rays in order to catalyze fusion. A solid chip target (such as Li⁶D) is preferred, but a properly contained liquid target (e.g., a chip of encapsulated D₂O) would also work in some less demanding applications since both cosmic rays and muons have sufficient energy to pass through a capsule's coating to interact with the liquid or frozen target material contained within the capsule.

The muons (and cosmic rays) are available here for free and do not need to be generated artificially in an accelerator. One cosmic ray particle can generate hundreds of muons, and each muon can typically catalyze about 100 fusion reactions before it decays (the exact number depending on the muon “sticking” cross-section to any helium fusion products). Additionally, any remaining cosmic rays can themselves directly stimulate a fusion event by particle-target fusion, wherein the high energy cosmic ray particles (mostly protons, but also helium nuclei) bombard relatively stationary target material.

Created by collisions of cosmic ray particles with atmospheric dust and molecules, muons are used in several ways in the present invention. The main reaction is in catalyzing fusion of two deuterium nuclei. The deuterium “fuel” may be supplied in the form of solid LiD chips, or even encapsulated heavy water (D₂O) or liquid deuterium (D₂). Other types of fusion reactions besides D-D are also possible depending upon the target material. For example, another LiD reaction is Li⁶+D→2He⁴+22.4 MeV, where much of the useful excess energy is carried as kinetic energy of the two helium nuclei (alpha particles). Additionally, when bombarded directly with cosmic rays, the lithium may be transmuted into tritium which could form the basis for some D-T fusion reactions.

Since the amount of generated energy is on the order of kilowatts, which is very much less than the fusion energy outputs or yields typical of atomic weapons, “micro-fusion” is the term used here to refer to fusion energy outputs of not more than 10 gigajoules per second (2.5 tons of TNT equivalent per second), to thereby exclude runaway macro-fusion-type explosions.

In the present invention, muons from cosmic ray decay replace electrons in deuterium, allowing for a reduced size molecule because, as realized by Charles Frank in 1927, being about 200 times more massive than electrons, muons orbit much nearer to the central nucleus than the electron replaced. Muonic deuterium can come much closer to the nucleus of a similar neighboring atom with a probability of fusing deuterium nuclei, releasing energy. Once a muonic molecule is formed, fusion proceeds extremely rapidly (on the order of 10⁻¹⁰ sec). The muon is usually released to catalyze about 100 other fusion reactions during its short life (2ρs at rest, but longer at relativistic speeds generated by cosmic rays). Although D-D fusion reactions occur at a rate only 1% of D-T fusion, and produce only 20% of the energy by comparison, the freely available flux of cosmic-ray-generated muons on planets (such as Mars), moons with thin atmospheres, on the highest mountains on Earth, or via satellites in orbit around Earth should be sufficient to yield sufficient energy output by muon-catalyzed fusion for practical use. Energetic protons, which make up about 90% of the cosmic rays, must have a collision energy loss of at least 300 MeV for a muon to be created. Most cosmic rays are energetic enough to create multiple muons (often several hundred) by successive collisions with atmospheric dust or with the atoms in a fusion chip target. Any cosmic rays that reach a fusion chip target at the Martian surface with sufficient residual energy can also directly induce some nuclear fusion events by particle-target type fusion, supplementing those obtained from the muons.

The present invention achieves muon-catalyzed nuclear fusion using deuterium-containing target material, and muons that are naturally created from ambient cosmic rays. Most cosmic rays are energetic enough to create multiple muons (often several hundred) by successive collisions with atmospheric dust or with the atoms in a target. In fact, most cosmic rays have GeV energies, although some extremely energetic ones can exceed 10¹⁸ eV and therefore potentially generate millions of muons. The optimum concentration of the fusion chip target material for the muon-catalyzed fusion may be determined experimentally based on the particular abundance of cosmic rays with a view to maintaining a chain reaction of fusion events for producing adequate heat, useful work or illumination photons for the specified application while avoiding any possibility of runaway fusion in the muon rich environment (each muon can catalyze multiple fusion events, as many as 100, before it eventually decays).

At a minimum, since muon-catalyzed fusion, while recognized, is still an experimentally immature technology (since measurements have only been conducted to date on Earth using artificially generated muons from particle accelerators), various embodiments of the present invention can have research utility to demonstrate feasibility in environments beyond Earth's protective atmosphere and/or geomagnetic field, initially above Earth's atmosphere (e.g. on satellite platforms or Earth's highest mountain tops) for trial purposes, and then on the Moon or the surface of Mars, in order to determine optimum parameters of the fusion chip arrays for various utilities in those environments. For example, the actual number of muon catalyzed fusion reactions for various types of fusion chip target configurations and fusion fuel sources, and the amount of heat, illumination, or useful work that can be derived from such reactions, are still unknown and need to be fully quantified in order to improve the technology.

### BRIEF DESCRIPTION OF THE DRAWINGS

FIGS. 1A and 1B are perspective views of the main elements of two space heater embodiments, one with coated plates in the form of circular disks and the other with coated plates in conical form with a selected downward-projecting angle.

FIG. 1C is a schematic cross-sectional view showing main space heater elements with passages filled with circulating fluid.

FIG. 1D is a schematic plan view showing tubes with circulating fluid arranged around the main space heater elements.

FIG. 1E is a schematic plan view showing a lining disposed around the plates of the main space heater elements.

FIG. 2 shows a subterranean dwelling heated by the space heater of any of FIGS. 1A-1E, wherein the coated plates are selectively raised or lowered for variable exposure to cosmic rays and muons, variable heat generation, variable heat transfer to the dwelling.

FIG. 3 is a schematic side plan view of an electrical generator with a coated strip at one mirror focus and an EM radiation receptive unit at a second mirror focus.

FIG. 4 is perspective view of a transport vehicle equipped with a coated panel serving as a propulsion unit.

FIG. 5 is a side schematic view of a paddle wheel unit for producing rotary motion, wherein paddles are coated.

FIG. 6 is a side schematic view of a mechanical lever for lifting a load, wherein one lever arm is coated.

FIG. 7 is a graph of cosmic ray flux at the Earth surface versus cosmic ray energy, after very significant cosmic ray absorption by Earth's atmosphere has occurred.

### DETAILED DESCRIPTION

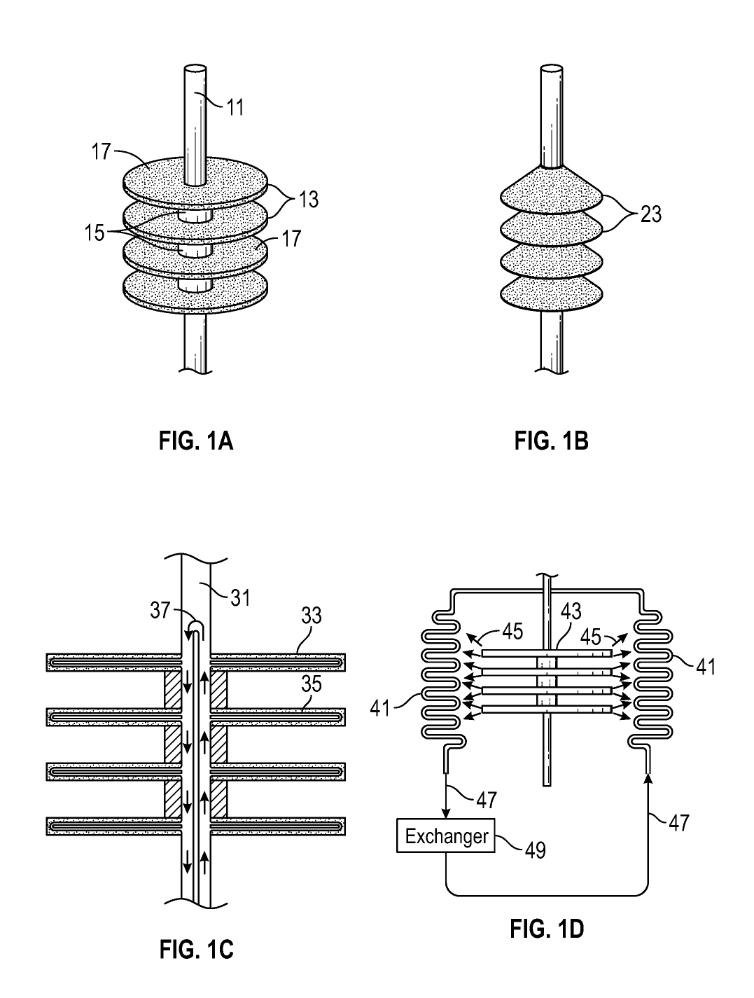

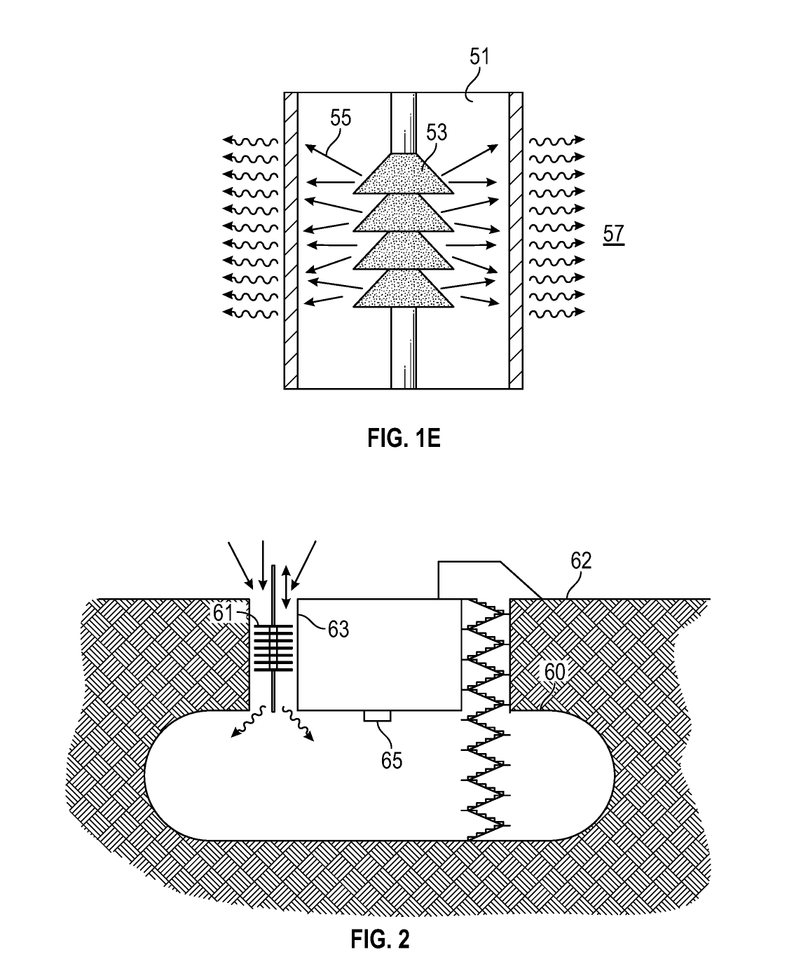

With reference to FIGS. 1A-1E, one possible use for muon-catalyzed or particle-target micro-fusion is as a fusion chip space heater usable in the presence of ambient flux of cosmic rays and muons, e.g. on the Martian surface. For example, a series of a dozen plates or disks slid onto a rod, and alternating with spacers, may have tiny chips of micro-fusion fuel bonded to those plates or disks. In one possible embodiment seen in FIG. 1A, the main space heater element comprises a plurality of plates 13 alternating with spacers 15 supported on a rod 11. A coating 17 of chips is disposed upon an upper surface of each plate 13. The chips comprise a deuterium-containing fuel material (such as Li⁶D or D₂O) that, when exposed to and interacting with the ambient flux of cosmic rays and muons generated from the cosmic rays, produce energetic micro-fusion reaction products together with usable heat. In FIG. 1A, the plates 13 are in the form of circular disks. However, in an alternate embodiment seen in FIG. 1B, plates 23 are conical with a downwardly-projecting angle. That angle may be selected to expose a maximum area of the upper surface of plates 23 and of the chips coating that surface to the ambient flux of cosmic rays and muons.

In either case, the chips may contain solid Li⁶D or may encapsulate liquid or frozen D₂O. However, even a Li⁶D chip material should be coated with an inert material to protect it against adverse chemical reaction during manufacture, transport and in the launch vehicle. The plates containing the fusion chip material should also be shielded against premature interactions with cosmic rays during its long travel to its destination. When subject to cosmic ray collisions, the disks become hot from the resulting fusion reactions. The optimum size of the tiny chips and the spacing between them can be determined with routine experimentation to ensure an adequate chain of fusion events that generate useful heat without runaway fusion.

As seen in FIG. 1C, the rod 31 and/or coated plates 33 (in whatever form, i.e. circular or conical) may have passages 35 therein filled with circulating fluid 37 to receive the heat generated by the reaction products. The circulating fluid 37 is in communication with a heat exchanger (not shown) that can be relatively remote from the main reaction elements 31 and 33.

Alternatively, as seen in FIG. 1D, a set of tubes 41 may be arranged around the coated plates 43 to receive the energetic reaction products 45. The tubes 41 are filled with a circulating fluid 47 which is heated when the tubes 41 absorb the kinetic energy from the reaction products 45. The circulating fluid is communication with a heat exchanger 49 that can be relatively remote from the main reaction elements 43.

Alternatively, as seen in FIG. 1E, a metal lining 51 may be disposed around the coated plates 53 to receive the energetic reaction products 55 and then transfer the heat generated in the lining 51 to surrounding spaces 57.

Thus, a fusion chip space heater can be created and seated on the Martian surface, where the fusion source material itself could be a cosmic ray target for the creation of muons, or where a separate cosmic ray target may be provided immediately adjacent to the fusion chip source material. Additionally, many muons naturally generated in the Martian atmosphere will arrive at the surface before decaying so as to be available to interact with the fusion source material. The kinetic energy of the fusion products can be transferred as heat to a metal lining, or tubes of water coupled to a heat exchanger. The kinetic energy could also be directly converted into electricity by any of a number of techniques including electrostatic collection. Photoelectric conversion of electromagnetic radiation may be possible using concentrically nested X-ray absorber and electron collector sheets (cf. U.S. Pat. No. 7,482,607 and U.S. Patent Application Publication 2013/0125963).

The space heater would be useful for providing warmth to designated spaces, such as mountain tops and underground dwellings 60 of a Mars colony. As seen in FIG. 2, the unit 61 can be situated in a shaft 63 leading to the surface 62, raised to the surface for exposure to the cosmic rays and muons, and lowered responsive to thermostatic sensors 65 in the dwelling 60 to provide more or less heat transfer from the unit to the dwellings. It could also be used to melt ice. Thus, as seen, the rod and chip-coated plates 61 are situated in the shaft 63. The unit 61 is adapted to be raised and lowered responsive to user-selected temperature settings and temperature sensors 65. As the unit 61 is raised or lowered, it obtains variable exposure to cosmic rays and muons, e.g. more when raised and less when lowered, and consequently variable heat generation. Likewise, the amount of heat transfer to the dwelling might depend upon the raising or lowering of the unit 61, e.g. if the unit's plates or disks, or a surrounding liner, directly heats surrounding spaces.

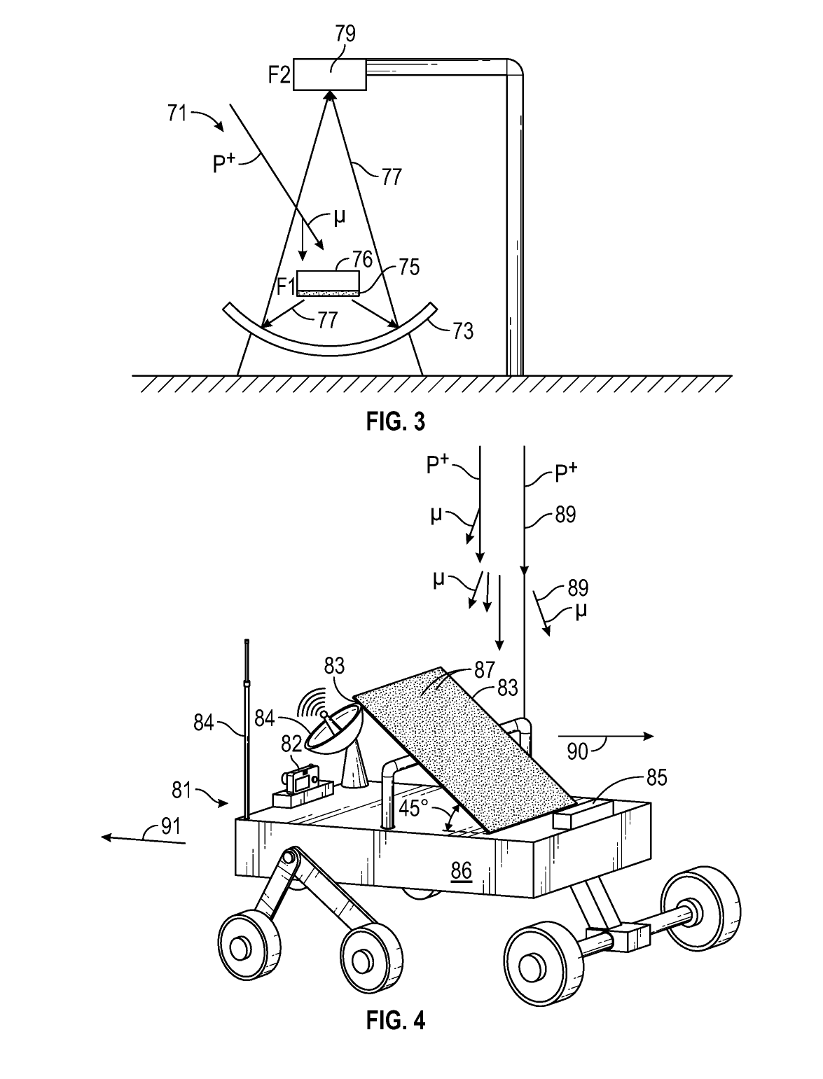

In yet another possible construction, shown in FIG. 3, an electrical generator 71 can make use of the cosmic-ray and muon-heating of the fuel chips. Thus, a concave (e.g. ellipsoidal) mirror 73 is provided with a first focal region F1 and a second focal region F2. The mirror 73 is reflective of EM radiation generated by any of muon-catalyzed and particle-target micro-fusion reactions. A rectangular or square plate or strip 75, e.g. a few centimeters on a side, is situated at the first focal region F1. The strip 75 is coated with chips comprising deuterium-containing fuel material 76 (e.g. Li⁶D or D₂O). A flux of muons generated from cosmic ray energetic proton collisions in the atmosphere hits the target and produces muon-catalyzed micro-fusion energy, some of which is electromagnetic (EM) radiation 77. Note that any cosmic rays reaching the planetary mountain tops intact can also generate muons when they collide with the fusion chip target. The EM radiation 77 is directed by the mirror 73 to a second focal location F2, where an EM receptive unit 79 is situated that is adapted to convert the received EM radiation into electricity. For example, the EM receptive unit 79 can comprise photovoltaic cells, or an x-ray absorber and electron collector unit, either of which convert the EM radiation 77 directly into electricity. The electricity can be stored in a battery for later use. Alternatively, the EM receptive unit might comprise tubes with circulating fluid (e.g. water) that is heated by the received EM radiation 77. The heated water can drive a generator or thermoelectric device, if desired, or can be supplied to a heat exchanger, or used as a source of hot water. For ease of transport through space, the mirror 73 may be composed of a flexible memory material that unfolds to the desired shape when deployed at its destination.

In yet another possible application, if the reaction rate can be optimized, the series of controlled fusion micro-explosions could be used to propel wheels or pistons to achieve physical motion (similar to driving the paddles of a water wheel or pistons of a combustion engine), where a surface to be propelled by the micro-explosions is coated with the fusion fuel material and exposed to cosmic rays and the cosmic-ray-generated muons. For example, as seen in FIG. 4, a transport vehicle 81 (such as one similar to existing Martian rovers) has one or more fusion panels 83 attached to it. The transport vehicle 81 would normally have other equipment attached to it, such as cameras 82, antennae 84, instrument packages 85, and an electronics box 86. In whatever way the vehicle is equipped, the fusion panel(s) 83 has fusion fuel pellets or chips 87 (e.g. of Li⁶D or encapsulated D₂O) adhered or otherwise mounted to an upper surface of the panel 83. Cosmic rays (and generated muons) 89 arrive vertically and interact with the fuel chip material 87, producing energetic reaction products 90. For direct propulsion, the panel may be oriented at 45° to produce maximum horizontal drive force from the fusion products 90 for vehicle motion 91. Alternatively, for conversion of fusion heat into electrical power to drive a motor, panels would best be oriented horizontally.

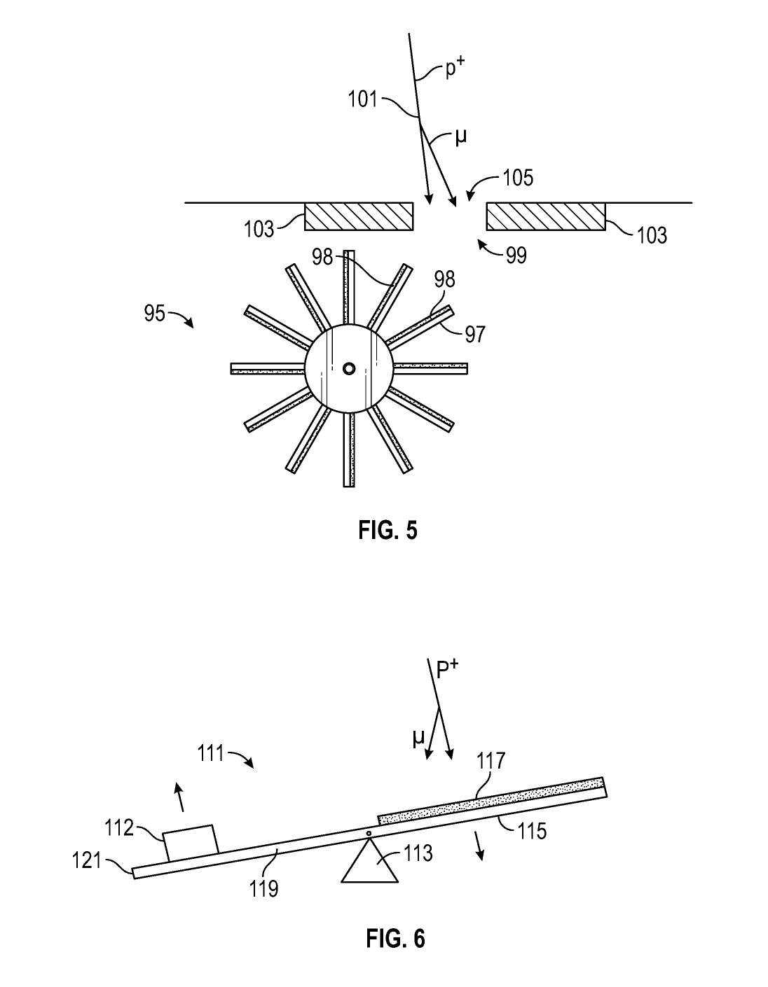

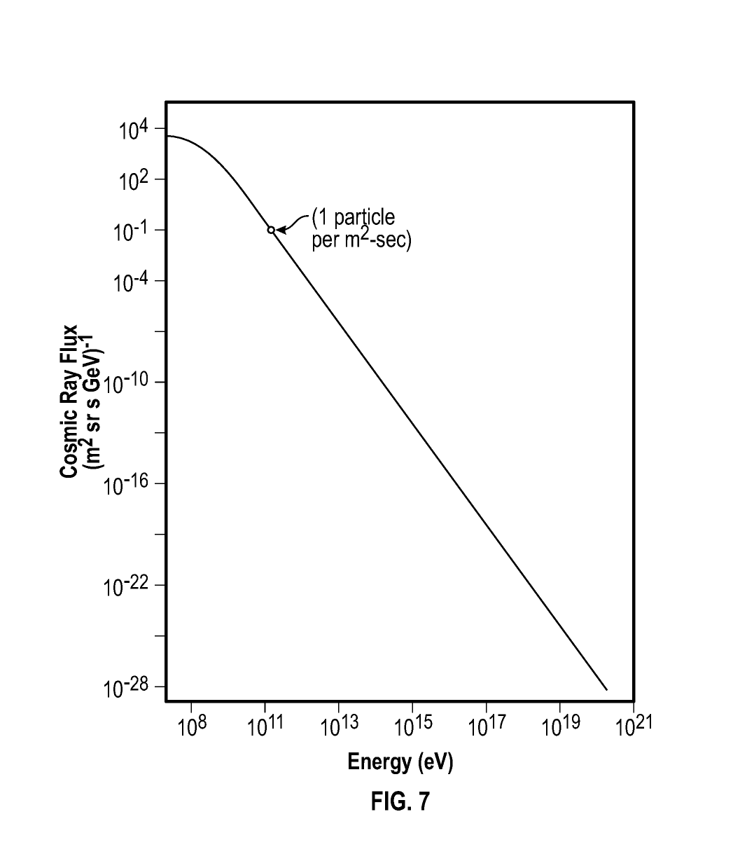

FIG. 5 illustrates the paddle wheel concept for achieving rotary motion. A paddle wheel 95 has a plurality of paddles 97 brought successively into an interaction region 99 where it is exposed to incoming cosmic rays and muons 101. Each paddle 97 has fusion fuel chips 98 attached on one side (the upper-facing side when rotated into the interaction region). Shielding material 103 is positioned above the paddle wheel 95 but has an opening 105 to let cosmic rays and muons 101 into the interaction region 99. Fusion products from the cosmic ray interaction generate a downward thrust that turns the paddle wheel 95. Moving the shielding 103 horizontally, or otherwise adjusting the size or position of the opening 105, so that less of the paddle 97 interacts with cosmic rays 101 can control the rotary speed of the wheel 95.

FIG. 6 illustrates still another possible use of cosmic-ray/muon catalyzed micro-fusion for doing physical work, in this case lifting of loads for mining or excavation. A mechanical lever 111 has a fulcrum 113 with a first lever arm 115, on one side of the fulcrum 113, coated on an upper surface with the micro-fusion fuel chips 117. A load 121 to be lifted is placed on a second lever arm 119 on the opposite side of the fulcrum 113. Cosmic rays and muons arrive vertically from above, interact with the coating of fuel chips 117 and generate fusion events that provide a downward propulsion force to the first lever arm 115, thereby lifting the load 121 on the second lever arm 119. Adaptations of this basic machine will optimize the mechanical advantage for a particular lifting operation.

What is claimed is:

1. A space heater usable in the presence of an ambient flux of cosmic rays, comprising:
a plurality of plates alternating with spacers supported on a rod; and
a coating of chips disposed upon an upper surface of each plate, the chips comprising a deuterium-containing fuel material that, when exposed to and interacting with the ambient flux of cosmic rays and muons generated from the cosmic rays, produce energetic reaction products together with usable heat.

2. The space heater as in claim 1, wherein energetic reaction products heat the plates containing the chips.

3. The space heater as in claim 2, wherein the rod and plates have passages therein filled with circulating fluid to receive the heat, the circulating fluid being in communication with a heat exchanger.

4. The space heater as in claim 1, further comprising a set of one or more tubes arranged around the plates and their coating of chips to receive the energetic reaction products and then transfer generated heat to fluid circulating within the set of tubes, the circulating fluid being in communication with a heat exchanger.

5. The space heater as in claim 1, further comprising a metal lining disposed around the plates and their coating of chips to receive the energetic reaction products and then transfer generated heat to surrounding spaces.

6. The space heater as in claim 1, wherein the plates are circular disks.

7. The space heater as in claim 1, wherein the plates are conical with a downward-projecting angle selected to expose a maximum area of the upper surfaces of the plates coated with the chips to the ambient flux of cosmic rays and muons.

8. The space heater as in claim 1, wherein the rod and chip-coated plates are situated in a shaft and are adapted to be raised and lowered responsive to user-selected temperature settings and temperature sensors for variable exposure to cosmic rays and muons, variable heat generation, and variable heat transfer.

9. The space heater as in claim 1, wherein the chips contain solid Li⁶D.

10. The space heater as in claim 1, wherein the chips encapsulate liquid or frozen D₂O.

11. An electrical generator usable in the presence of an ambient flux of cosmic rays, comprising:
a concave mirror having a first focal region and a second focal region, the mirror being reflective of EM radiation generated by any of muon-catalyzed and particle-target micro-fusion reactions;
a strip situated at the first focal region and coated with chips comprising a deuterium-containing fuel material, that, when exposed to and interacting with the ambient flux of cosmic rays and muons generated from the cosmic rays, produce EM radiation; and
an EM radiation receptive unit situated at the second focal region adapted to convert received EM radiation into electricity.

12. The electrical generator as in claim 11, wherein the EM radiation receptive unit comprises an x-ray absorber and electron collector unit.

13. The electrical generator as in claim 11, wherein the EM radiation receptive unit comprises tubes with circulating fluid that is heated by received EM radiation at the second focal region, the circulating fluid driving a generator.

14. The electrical generator as in claim 11, wherein the chips coating the strip at the first focal region contain solid Li⁶D.

15. The electrical generator as in claim 11, wherein the chips coating the strip at the first focal region encapsulate liquid or frozen D₂O.

16. A propulsion unit for a transport vehicle that is usable in the presence of an ambient flux of cosmic rays, comprising:
a panel mounted on the transport vehicle; and
a coating of chips disposed on an upper surface of the panel, the chips comprising a deuterium-containing fuel material that, when exposed to and interacting with the ambient flux of cosmic rays and muons generated from the cosmic rays, produce energetic reaction products.

17. The propulsion unit as in claim 16, wherein the panel is oriented at a selected angle from the horizontal such that the energetic reaction products provide a horizontal drive force or thrust to the transport vehicle.

18. The propulsion unit as in claim 17, wherein the selected angle is 45° from horizontal.

19. The propulsion unit as in claim 16, wherein the panel is heated by the energetic reaction products, the propulsion unit having a thermoelectric unit to convert the heat to electricity for driving the transport vehicle.

20. The propulsion unit as in claim 16, wherein the chips coating the panel contain solid Li⁶D.

21. The propulsion unit as in claim 16, wherein the chips coating the panel encapsulate liquid or frozen D₂O.

22. A unit for producing rotary motion for doing physical work, the unit usable in the presence of an ambient flux of cosmic rays, comprising:
a paddle wheel having a plurality of paddles brought successively into an interaction region;
a coating of chips disposed on one surface of each paddle that is an upper surface whenever the paddle is in the interaction region, the chips comprising a deuterium-containing fuel material that, when exposed to and interacting with the ambient flux of cosmic rays and muons generated from the cosmic rays in the interactive region, produce energetic reaction products providing a downward drive force or thrust to turn the paddle wheel; and
shielding material positioned above the paddle wheel with an opening to let cosmic rays and muons only into the interaction region.

23. The unit for producing rotary motion as in claim 22, wherein the size or location of the opening in the shielding material is variable to allow a selective amount of cosmic rays and muons into the interaction region to control rotary speed of the paddle wheel.

24. The unit for producing rotary motion as in claim 22, wherein the chips coating the paddles contain solid Li⁶D.

25. The unit for producing rotary motion as in claim 22, wherein the chips coating the paddles encapsulate liquid or frozen D₂O.

26. A mechanical lever usable in the presence of an ambient flux of cosmic rays for lifting a load, comprising:
a fulcrum and two opposed lever arms, a first lever arm adapted to accept a load to be lifted;
a coating of a chips disposed on an upper surface of a second lever arm, the chips comprising a deuterium-containing fuel material that, when exposed to and interacting with the ambient flux of cosmic rays and muons generated from the cosmic rays, produce energetic reaction products providing a downward drive force or thrust to the second lever arm and a lifting force to the first lever arm; and
shielding selectively movable over the first lever arm to control the amount of the ambient flux of cosmic rays and muons interacting with the chips.

27. The mechanical lever as in claim 26, wherein the chips coating the second lever arm contain solid Li⁶D.

28. The mechanical lever as in claim 26, wherein the chips coating the second lever arm encapsulate liquid or frozen D₂O.
